(19) United States
(12) Patent Application Publication
(10) Pub. No.: US 2025/0071729 A1
(43) Pub. Date: Feb. 27, 2025

(54) Paging Early Indication Technique for Relaying

(71) Applicant: Telefonaktiebolaget LM Ericsson (PUBL), Stockholm (SE)

(72) Inventors: Mattias Bergström, SOLLENTUNA (SE); Martin van der Zee, MALMÖ (SE); Antonino Orsino, KIRKKONUMMI (FI)

(21) Appl. No.: 18/718,145

(22) PCT Filed: Dec. 21, 2022
(86) PCT No.: PCT/EP2022/087256

§ 371 Date: Jun. 10, 2024

Related U.S. Application Data
(60) Provisional application No. 63/265,864, filed on Dec. 22, 2021.

(51) Int. Cl. H04W 68/00; H04W 88/04

(52) U.S. Cl. CPC H04W 68/005; H04W 88/04

(57) ABSTRACT

A technique for relaying a paging message from a network node (300; 1800; 1912; 2020) to a remote radio device (200; 1700; 1991; 1992; 2030) is described. As to a method (400) aspect of the technique performed by a relay radio device (100; 1600; 1991; 1992; 2030), the paging message is received (404) on a downlink, DL (722), from the network node (300; 1800; 1912; 2020) at the relay radio device (100; 1600; 1991; 1992; 2030). The received (404) paging message is relayed (408) on a sidelink, SL (730), from the relay radio device (100; 1600; 1991; 1992; 2030) to the remote radio device (200; 1700; 1991; 1992; 2030). The paging message is selectively announced by a paging early indication, PEI, on the DL (722) from the network node (300; 1800; 1912; 2020) at the relay radio device (100; 1600; 1991; 1992; 2030) depending on whether the relay radio device (100; 1600; 1991; 1992; 2030) supports receiving of the PEI and/or independent of whether the remote radio device (200; 1700; 1991; 1992; 2030) supports receiving of the PEI.

### TECHNICAL FIELD

The present disclosure relates to a paging early indication technique for relaying traffic using a sidelink between radio devices. More specifically, and without limitation, methods and devices are provided for relaying a paging message from a network node through a relay radio device to a remote radio device.

### BACKGROUND

The Third Generation Partnership Project (3GPP) defined sidelinks (SLs) in Release 12 as an adaptation of the Long Term Evolution (LTE) radio access technology for direct communication between two radio devices, also referred to as user equipment (UE), without going through a base station. Such device-to-device (D2D) communications through SLs are also referred to as proximity service (ProSe) and can be used for Public Safety communications. While conventional public safety communications use different standards in different geographical regions and countries, 3GPP SL communications enable interworking of different public safety groups. 3GPP has enriched SLs in Release 13 for public safety and commercial communication use-cases and, in Release 14, for vehicle-to-everything (V2X) scenarios.

3GPP specified SL relaying in Release 13 for LTE targeting safety use-cases. Therefore, selection of a relay radio device and connection establishment between a remote radio device and the relay radio device is conventionally agnostic as to priorities and requirements of the traffic to be relayed. Particularly, there is no way to guarantee that the selected relay radio device can fulfil quality requirements specifically for the traffic.

3GPP has defined and enhanced features for the SL and for SL relaying in Fifth Generation New Radio (5G NR, or briefly: NR).

3GPP Release 17 for 5G NR introduced paging enhancements for UE power saving, which include Early Paging Indication (EPI). According to the earlier Release 15, if the UE experiences high false paging or very rare paging, the UE may consume high power resulting in fast battery drain.

According to EPI, the UE is notified in advance of its Paging Occasion (PO), i.e. whether the UE has to monitor the PO. As a result, the UE can skip the time-frequency synchronization prior to those POs the UE does not need to monitor.

However, according to the prior art, the network would, when it sends a paging message for a relay UE, consider the capability of the relay UE as to a paging early indication (PEI). And when the network sends paging message for a remote UE, the network would consider the PEI capabilities of the remote UE. This prior art situation may be summarized as indicated in the following table.

| | Relay UE | Relay UE does not |
|---|---|---|
| | supports PEI | support PEI |
| Remote UE supports PEI | PEI for relay paging | No PEI for relay paging |
| | PEI for remote | PEI for remote paging |
| | paging | |
| Remote UE does not | PEI for relay paging | No PEI for relay paging |
| support PEI | No PEI for remote | No PEI for remote |
| | paging | paging |

This prior art behavior can cause at least one of the following two issues. As a first issue, in case a remote UE does not support PEI while the relay UE supports PEI, the network would, when it sends a paging message for the remote UE, not send a PEI. The relay UE would, however, only receive a paging message if it is preceded by a PEI. This means that paging of the remote UE would fail.

Similarly, as a second issue, if the remote UE supports PEI but the relay UE does not support PEI, the network would, when it pages the remote UE, send PEI before the paging for the remote UE. However, the relay UE would not listen to PEI but would always read the paging. This means that the network would be sending PEI which are not considered, meaning those PEI transmissions would be unnecessary. These unnecessary PEI transmissions would therefore be wasteful transmissions which increases interference and network power consumption.

### SUMMARY

Accordingly, there is a need for a sidelink relaying technique that reliably enables paging early indications.

As to a first method aspect, a method performed by a relay radio device for relaying a paging message from a network node to a remote radio device is provided. The method comprises or initiates the step of receiving the paging message on a downlink (DL) from the network node at the relay radio device. The method further comprises or initiates the step of relaying the received paging message on a sidelink (SL), from the relay radio device to the remote radio device. The paging message is (e.g., selectively) announced by a paging early indication (PEI) on the DL (e.g., received) from the network node at the relay radio device depending on whether the relay radio device supports receiving of the PEI and/or independent of whether the remote radio device supports receiving of the PEI.

Receiving the paging message at the relay radio device and relaying the received paging message to the remote radio device may also be referred to as relaying the paging message from a network node through the relay radio device to a remote radio device.

Relaying the control message may comprise forwarding the paging message, e.g., conveying the paging message verbatim or as received (optionally encapsulated as a service data unit, SDU, in a protocol data unit, PDU) from the network node to the remote radio device.

The PO and/or a paging frame (PF) may be defined according to 3GPP document TS 36.304, version 16.5.0, or TS 38.304, version 16.6.0. Alternatively or in addition, the PO of the remote radio device may be a slot or subframe, in which paging downlink control information (DCI) scrambled by a paging radio network temporary identifier (P-RNTI) of the remote radio device can be transmitted on a physical downlink control channel (PDCCH). Alternatively or in addition, the PF may be one radio frame comprising one or multiple POs.

The paging message (e.g., according to the first method aspect) may be received in a paging occasion (PO) of the remote radio device.

The paging message (e.g., according to the first method aspect) may be received in a paging occasion (PO) of the relay radio device.

The paging message (e.g., according to the first method aspect) may be announced by receiving the PEI in the DL from the network node at the relay radio device.

In other words, the receiving of the PEI may be indicative of the paging message (e.g., in the PO). Since the PEI may be received prior to the PO in which the paging message is received, the PO may be referred to as an upcoming (e.g., subsequent) PO relative to the PEI.

The PEI may also be referred to as a wake-up signal (WUS).

The paging message (e.g., according to the first method aspect) may be announced by not receiving the PEI in the DL from the network node at the relay radio device.

In other words, the absence of the PEI in a PEI occasion may be indicative of the paging message (e.g., in the PO). Since the PEI occasion may be prior to the PO in which the paging message is received, the PO may be referred to as an upcoming (e.g., subsequent) PO relative to the PEI occasion.

For example, the network node transmits the PEI every time when there is no paging message to be transmitted. At the relay radio device, in the absence of hearing anything (i.e., when not receiving the PEI), the relay radio device monitors the PO for the paging message.

The PEI may also be referred to as a go-to-sleep signal (GTS).

The WUS can require less radio resources and/or can achieve more power saving compared to the GTS. The GTS can be more reliable (e.g., since the mechanism can be robust against loss of the GTS) and/or can achieve less latency compared to the WUS.

While the present disclosure primarily refers to the PEI acting as a WUS, any feature or step may also be applied to the PEI acting as a GTS. For example, whenever referring to the “receiving of the PEI”, the corresponding feature or step may be implemented or triggered by the absence of the PEI.

The paging message (e.g., according to the first method aspect) may be selectively announced by the PEI from the network node at the relay radio device in accordance with whether a further paging message addressed to the relay radio device is announced by a or the PEI from the network node at the relay radio device.

The paging message may be addressed to the remote radio device based on the PO in which the paging message is received. For example, the PO may be (e.g., non-exclusively) associated with the remote radio device, e.g., according to at least one of an international mobile subscriber identity (IMSI), a serving temporary mobile subscriber identity (S-TMSI), a 5G-S-TMSI, and an inactive radio network temporary identifier (I-RNTI) of the remote radio device. Alternatively or in addition, the paging message (e.g., a downlink control information, DCI) may comprise a cyclic redundancy check (CRC) value that is scrambled with an identity or identifier of the remote radio device, e.g. a paging temporary network identifier (P-RNTI).

The further paging message may be addressed to the relay radio device based on the PO in which the further paging message is received. For example, the PO of the further paging message may be (e.g., non-exclusively) associated with the relay radio device, e.g., according to at least one of an IMSI, a S-TMSI, a 5G-S-TMSI, and an I-RNTI of the relay radio device. Alternatively or in addition, the further paging message (e.g., a DCI) may comprise a CRC value that is scrambled with an identity or identifier of the relay radio device, e.g. a P-RNTI.

A control plane and/or a physical layer of the DL and/or the SL may be implemented according to the 3GPP document TS 38.213, version 16.7.0 (e.g., Chapter 16 on the SL).

The paging message (e.g., according to the first method aspect) may be addressed to the remote radio device. The method (e.g., according to the first method aspect) may further comprise or initiate the step of receiving a or the further paging message in the DL from the network node at the relay radio device in a PO of the relay radio device, the further paging message being addressed to the relay radio device. Alternatively or in addition, both the paging message addressed to the remote radio device and the further paging message addressed to the relay radio device are announced by the PEI from the network node at the relay radio device.

Herein, a PO may comprise a set of occasions for monitoring a physical downlink control channel (PDCCH) of the network node. Alternatively or in addition, the PO may comprise one or multiple temporal radio resources, e.g., resources used for the DL in the time domain. Alternatively or in addition, the PO may comprise one or more slots, one or more subframes, or one or more orthogonal frequency-division multiplexing (OFDM) symbols.

The PEI may be indicative of both the paging message and the further paging message. Alternatively or in addition, the PEI may be indicative of an on-duration encompassing both the PO for the receiving of the paging message and the PO for the receiving of the further paging message.

The paging message (e.g., according to the first method aspect) may be announced by the PEI in the DL from the network node at the relay radio device if the relay radio device supports the receiving of the PEI. Alternatively or in addition, the paging message is not announced in the DL by a PEI from the network node if the relay radio device does not support the receiving of the PEI.

The paging message (e.g., according to the first method aspect) may be announced by transmitting a SL PEI in the SL from the relay radio device to the remote radio device if the remote radio device supports the receiving of the SL PEI. Alternatively or in addition, the paging message is not announced in the SL by a SL PEI from the relay radio device if the remote radio device does not support the receiving of the SL PEI.

One of the relay radio device and the remote radio device may support receiving the PEI (e.g., according to the first and/or second method aspect). The other one of the relay radio device and the remote radio device may not support receiving a PEI.

The relay radio device and the remote radio device may be a supporting device that supports receiving a PEI and a non-supporting device that does not support receiving a PEI.

For example, the relay radio device may support receiving the PEI and the remote radio device does not support receiving a PEI. Alternatively, the relay radio device does not support receiving the PEI and the remote radio device supports receiving a PEI.

The paging message (e.g., according to the first method aspect) may be announced by the receiving of the PEI in the DL from the network node at the relay radio device if the relay radio device supports the receiving of the PEI. The paging message may be announced by forwarding the PEI in the SL from the relay radio device to the remote radio device if the remote radio device supports the receiving of the PEI.

The relay radio device (e.g., according to the first method aspect) may support the receiving of the PEI based on at least one of the following steps. The steps may include a step of receiving a configuration message in the DL from the network node at the relay radio device. The configuration message may configure the relay radio device to receive the PEI. The steps may include a step of receiving a configuration message in the SL from the remote radio device at the relay radio device. The configuration message may configure the relay radio device to receive the PEI. The steps may include a step of transmitting a capability message in an uplink (UL), from the relay radio device to the network node. The capability message may be indicative of whether the relay radio device is capable of receiving the PEI. The steps may include a step of transmitting a or the capability message in the SL from the relay radio device to the remote radio device. The capability message may be indicative of whether the relay radio device is capable of receiving the PEI.

The remote radio device (e.g., according to the first method aspect) may support the receiving of the PEI based on at least one of the following steps. The steps may include a step of transmitting a configuration message, or forwarding the configuration message, in the SL from the relay radio device to the remote radio device, wherein the configuration message configures the remote radio device to receive the PEI. Alternatively or in addition, the steps may include a step of receiving a capability message in the SL from the remote radio device at the relay radio device, the capability message being indicative of whether the remote radio device is capable of receiving the PEI.

Supporting the receiving of the PEI (e.g., being configured to and/or capable of the receiving of the PEI) may comprise at least one of activating a receiver of the respective radio device for the receiving of the PEI and/or activating the receiver of the respective radio device in the PO associated with the PEI for the receiving of the paging message if (e.g., only if) the PEI is received.

The method (e.g., according to the first method aspect), wherein the PEI may be a wake-up signal (WUS) or a go-to-sleep (GTS) signal.

The PEI (e.g., received at the relay radio device and/or the remote radio device) may control the relay radio device and/or remote radio device, respectively, to receive the paging message in the PO associated with the PEI.

The method (e.g., according to the first method aspect), wherein the PO may be associated to the PEI by a predefined time offset relative to the PEI.

Herein, predefined may encompass configured (e.g., by the network node, the relay radio device, and/or the remote radio device) and/or specified by a technical standard (e.g., hard-coded at the network node, the relay radio device, and/or the remote radio device).

The time offset may be broadcasted by the network node, e.g., in system information (SI).

The paging message (e.g., according to the first method aspect) may comprise paging downlink control information (DCI) on a physical downlink control channel (PDCCH) of the network node. Optionally, the paging message may comprise at least one of a message on a physical downlink shared channel (PDSCH); a message scheduled by the paging DCI; a message indicative of radio resource control (RRC) signaling; and a message indicative of system information (SI).

The paging DCI may be indicative of the scheduled message with same-slot or cross-slot scheduling.

The relay radio device (e.g., according to the first method aspect) may monitor PEI occasions of the relay radio device for receiving the PEI in the DL. The PEI received in one of the monitored PEI occasions in the DL for announcing the paging message may be indicative of a paging subgroup of at least one of the relay radio device and the remote radio device.

The method may comprise the step of monitoring PEI occasions for receiving the PEI. The radio device may monitor only PEI occasions associated with the relay radio device.

The relay radio device (e.g., according to the first method aspect) may monitor PEI occasions of the remote radio device for receiving the PEI in the DL. The PEI received in one of the monitored PEI occasions in the DL for announcing the paging message may be indicative of a paging subgroup of at least one of the relay radio device and the remote radio device.

Herein, PEI may encompass a PEI message (e.g., based on a DCI in the DL or an SCI in the SL). The PEI may be indicative of the subgroup of at least one of the relay radio device and the remote radio device. In other words, subgrouping of the radio devices for the paging may be implemented by including additional information (i.e., indicative of the subgroup) in the PEI for both relay radio device and remote radio device. Alternatively or in addition, subgrouping may use multiple P-RNTIs.

The remote radio device (e.g., according to the first method aspect) may be out of a radio coverage of the network node.

As to a second method aspect, a method performed by a remote radio device for relaying a paging message from a network node to the remote radio device is provided. The method comprises or initiates the step of receiving the paging message on a sidelink (SL), from a relay radio device at the remote radio device in a SL paging occasion (PO) of the remote radio device. The paging message is (e.g., selectively) announced by a SL paging early indication (PEI) on the SL (e.g., received) from the relay radio device at the remote radio device depending on whether the remote radio device supports receiving of the SL PEI and/or independent of whether the relay radio device supports receiving of a PEI from the network node.

The paging message may be announced by receiving the PEI in the SL from the relay radio device at the remote radio device. Alternatively, the paging message is announced by not receiving the PEI in the SL from the relay radio device at the remote radio device.

The method (e.g., according to the second method aspect) may further comprise any one of the features or steps of the first method aspect, or any feature or step corresponding thereto, e.g., a receiver counterpart to a transmitter feature or step.

As to a third method aspect, a method performed by a network node for relaying a paging message from the network node to a remote radio device is provided. The method comprises or initiates the step of transmitting the paging message on a downlink (DL), from the network node to a relay radio device, for relaying the transmitted paging message on a sidelink (SL), from the relay radio device to the remote radio device. The paging message is (e.g., selectively) announced by a paging early indication (PEI) on the DL (e.g., transmitted) from the network node to the relay radio device depending on whether the relay radio device supports the receiving of the PEI and/or independent of whether the remote radio device supports the receiving of the PEI.

The paging message (e.g., according to the third method aspect) may be transmitted in a paging occasion (PO) of the remote radio device. Alternatively or in addition, the paging message (e.g., according to the third method aspect) may be transmitted in a paging occasion (PO) of the relay radio device.

The paging message (e.g., according to the third method aspect) may be announced by transmitting the PEI in the DL from the network node to the relay radio device. Alternatively, the paging message (e.g., according to the third method aspect) may be announced by not transmitting the PEI in the DL from the network node to the relay radio device.

The method (e.g., according to the third method aspect) may further comprise any one of the features or steps of the first method aspect or the second method aspect, or any feature or step corresponding thereto, e.g. a receiver counterpart to a transmitter feature or step.

As to another aspect, a computer program product is provided. The computer program product comprises program code portions for performing any one of the steps of the first and/or second and/or third method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the first and/or second and/or third method aspect may be encoded in a Field-Programmable Gate Array (FPGA) and/or an Application-Specific Integrated Circuit (ASIC), or the functionality may be provided for download by means of a hardware description language.

In any aspect (e.g., at the network node and/or any one of the radio devices), at least some of embodiments can ensure that when the network node pages the remote radio device in a relay-scenario (i.e., through the relay radio device), the remote radio device and/or the relay radio device will successfully receive their paging messages. In some embodiments, this is ensured by that, when the network node should page the remote radio device, the network node determines whether or not to apply the PEI (i.e., whether not to announce the paging message by means of the PEI according to the selectively announcing) based on at least one PEI capability of the relay radio device.

Alternatively or in addition, the table below may describe a behavior (e.g., as to the selectively announcing of the paging message) of the network node and/or the relay radio device when implementing some of the embodiments described herein (wherein “supports PEI” may refer to “supports receiving of the PEI”):

| | Relay radio device | Relay radio device does not |
|---|---|---|
| | supports PEI | support PEI |
| Remote radio | PEI is applied for paging | No PEI is applied for |
| device supports | the relay radio device | paging the relay |
| PEI | PEI is applied for paging | radio device |
| | the remote radio device | No PEI is applied for |
| | | paging the remote |
| | | radio device |
| Remote radio | PEI is applied for paging | No PEI is applied for |
| device does not | the relay radio device | paging the relay |
| support PEI | PEI is applied for paging | radio device |
| | the remote radio device | No PEI is applied for |
| | | paging the remote |
| | | radio device |

Alternatively or in addition, e.g. by exchanging a configuration message and/or a capability message between the radio devices and/or between the relay radio device and the network node, in at least some embodiments when the relay radio device is used for paging the remote radio device, the network node knows if the relay radio device supports the PEI.

For brevity and without limitation, the radio devices may be referred to as user equipments (UEs). Without limitation, for example in a 3GPP implementation, any “radio device” may be a user equipment (UE). Any one of the method aspects may be embodied by a method of selectively announcing the paging message (e.g., selectively transmitting and/or monitoring a PEI occasion for the PEI) for relaying the paging message.

The technique may be applied in the context of 3GPP New Radio (NR). Unlike a SL according to 3GPP LTE, a SL according to 3GPP NR can provide a wide range of Qos levels. Therefore, at least some embodiments of the technique can ensure that the paging message is relayed to the remote radio device in fulfilment of a Qos associated with the paging message (or an associated application).

The technique may be implemented in accordance with a 3GPP specification, e.g., for 3GPP release 17, 18 or later. The technique may be implemented for 3GPP LTE based on, or according to a modification of, the 3GPP document TS 36.304, version 16.5.0. Alternatively or in addition, the technique may be implemented for 3GPP NR based on, or according to a modification of, the 3GPP document TS 38.213, version 16.7.0; and/or 3GPP TS 38.304, version 16.6.0; and/or 3GPP TS 38.413, version 16.7.0.

In any radio access technology (RAT), the technique may be implemented for SL relay selection, e.g., based on the PEI capability of the relay radio device. The SL may be implemented using proximity services (ProSe), e.g. according to a 3GPP specification.

Any radio device may be a user equipment (UE), e.g., according to a 3GPP specification. The relay radio device may also be referred to as a relay UE (or briefly: relay). Alternatively or in addition, the remote radio device may also be referred to as a remote UE. Alternatively or in addition, the further radio device may also be referred to as a further UE.

A radio access network (RAN) may comprise at least the network node. The network node and/or the RAN may serve at least one or each of the relay radio device and the remote radio device.

The relay radio device and the network node (or the RAN) may be wirelessly connected in an uplink (UL) and/or a downlink (DL) through a Uu interface. Alternatively or in addition, the SL may enable a direct radio communication between proximal radio devices, e.g., the remote radio device and the relay radio device, optionally using a PC5 interface. Services provided using the SL or the PC5 interface may be referred to as proximity services (ProSe). Any radio device (e.g., the remote radio device and/or the relay radio device and/or the further radio device) supporting a SL may be referred to as ProSe-enabled radio device.

The relay radio device may also be referred to as ProSe UE-to-Network Relay.

The remote radio device and/or the relay radio device and/or the network node (or the RAN) may form, or may be part of, a radio network, e.g., according to the Third Generation Partnership Project (3GPP) or according to the standard family IEEE 802.11 (Wi-Fi). The first method aspect, the second method aspect and third method aspect may be performed by one or more embodiments of the remote radio device, the relay radio device and the network node (e.g., a base station or the RAN), respectively.

The RAN may comprise one or more base stations, e.g., performing the third method aspect. Alternatively or in addition, the radio network may be a vehicular, ad hoc and/or mesh network comprising two or more radio devices, e.g., acting as the remote radio device and/or the relay radio device.

Any of the radio devices may be a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more embodiments of the network node (e.g., a base station).

The remote radio device may be wirelessly connected or connectable (e.g., according to a radio resource control, RRC, state or active mode) with the relay radio device and, optionally, at least one base station of the RAN. The relay radio device may be wirelessly connected or connectable (e.g., according to a radio resource control, RRC, state or active mode) with the network node (e.g., at least one base station or cell or beam of the RAN). Furthermore, the relay radio device may be wirelessly connected or connectable (e.g., according to 3GPP ProSe) with the remote radio device.

The network node may encompass any station (e.g., base station) that is configured to provide radio access to any of the radio devices. The base stations may also be referred to as cell, transmission and reception point (TRP), radio access node or access point (AP). The base station and/or the relay radio device may provide a data link to a host computer providing the user data to the remote radio device or gathering user data from the remote radio device. Examples for the base stations may include a 3G base station or Node B, 4G base station or eNodeB, a 5G base station or gNodeB, a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication.

Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

As to a first device aspect, a device (e.g., a relay radio device or UE) for relaying a paging message from a network node to a remote radio device is provided. The relay radio device comprises memory operable to store instructions and processing circuitry (e.g., at least one processor and a memory) operable to execute the instructions, such that the relay radio device is operable to receive the paging message on a downlink (DL) from the network node at the relay radio device. The relay radio device is further operable to relay the received paging message on a sidelink (SL) from the relay radio device to the remote radio device. The paging message is selectively announced by a paging early indication (PEI) on the DL from the network node at the relay radio device depending on whether the relay radio device supports receiving of the PEI and/or independent of whether the remote radio device supports receiving of the PEI.

The relay radio device (e.g., according to the first device aspect) may further be operable to perform any one of the steps of the first method aspect.

As to another first device aspect, a relay radio device for relaying a paging message from a network node to a remote radio device is provided. The relay radio device is configured to receive the paging message on a downlink (DL), from the network node at the relay radio device. The relay radio device is further configured to relay the received paging message on a sidelink (SL) from the relay radio device to the remote radio device. The paging message is selectively announced by a paging early indication (PEI) on the DL from the network node at the relay radio device depending on whether the relay radio device supports receiving of the PEI and/or independent of whether the remote radio device supports receiving of the PEI.

The relay radio device (e.g., according to the first device aspect) may further be configured to perform any one of the steps of the first method aspect.

As to a further first device aspect, a user equipment (UE) configured to communicate with a base station as the network node or with another UE as the remote radio device is provided. The UE may be embodying the relay radio device of any one of the first device aspects.

As to a second device aspect, a device (e.g., a remote radio device or UE) for relaying a paging message from a network node to the remote radio device is provided. The remote radio device comprises memory operable to store instructions and processing circuitry operable to execute the instructions, such that the remote radio device is operable to receive the paging message on a sidelink (SL), from a relay radio device at the remote radio device in a SL paging occasion (PO) of the remote radio device. The paging message is selectively announced by a SL paging early indication (PEI) on the SL from the relay radio device at the remote radio device depending on whether the remote radio device supports receiving of the SL PEI and/or independent of whether the relay radio device supports receiving of a PEI from the network node.

The remote radio device (e.g., according to the second device aspect) may further be operable to perform any one of the steps of the second method aspect.

As to another second device aspect, a remote radio device for relaying a paging message from a network node to the remote radio device is provided. The remote radio device is configured to receive the paging message on a sidelink (SL), from a relay radio device at the remote radio device in a SL paging occasion (PO) of the remote radio device. The paging message is selectively announced by a SL paging early indication (PEI) on the SL from the relay radio device at the remote radio device depending on whether the remote radio device supports receiving of the SL PEI and/or independent of whether the relay radio device supports receiving of a PEI from the network node.

The remote radio device (e.g., according to the second device aspect) may further be configured to perform any one of the steps of the second method aspect.

As to a further second device aspect, a user equipment (UE) configured to communicate with a base station as the network node or with another UE as the relay radio device is provided. The UE embodies the remote radio device of any one of the second device aspects.

As to a third device aspect, a device (e.g., a network node or gNB) for relaying a paging message from the network node to a remote radio device is provided. The device (e.g., a network node) comprises memory operable to store instructions and processing circuitry operable to execute the instructions, such that the network node is operable to transmit the paging message on a downlink (DL), from the network node to a relay radio device for relaying the transmitted paging message on a sidelink (SL), from the relay radio device to the remote radio device. The paging message is selectively announced by a paging early indication (PEI) on the DL from the network node to the relay radio device depending on whether the relay radio device supports the receiving of the PEI and/or independent of whether the remote radio device supports the receiving of the PEI.

The network node (e.g., according to the third device aspect) may be further operable to perform any one of the steps of the third method aspect.

As to another third device aspect, a network node for relaying a paging message from the network node to a remote radio device is provided. The network node is configured to transmit the paging message on a downlink (DL), from the network node to a relay radio device for relaying the transmitted paging message on a sidelink (SL), from the relay radio device to the remote radio device. The paging message is selectively announced by a paging early indication (PEI) on the DL from the network node to the relay radio device depending on whether the relay radio device supports the receiving of the PEI and/or independent of whether the remote radio device supports the receiving of the PEI.

The network node (e.g., according to the third device aspect) may further be configured to perform any one of the steps of the third method aspect.

As to a further third device aspect, a base station configured to communicate with a user equipment (UE) as the relay radio device is provided. The base station embodies the network node of any one of the third device aspect.

As to a still further aspect, a communication system including a host computer is provided. The host computer comprises a processing circuitry configured to provide user data, e.g., included in the paging message. The host computer further comprises a communication interface configured to forward the data to a cellular network (e.g., network node or the RAN) for (e.g., relay) transmission to a UE (e.g., the remote radio device). A processing circuitry of the cellular network is configured to execute any one of the steps of the third method aspect. The (e.g., relay and/or remote) UE comprises a radio interface and processing circuitry, which is configured to execute any one of the steps of the first and/or second method aspects.

The communication system may further include the (e.g., remote and/or relay) UEs. Alternatively, or in addition, the cellular network may further include one or more base stations configured for radio communication with the UE and/or to provide a data link between the UE and the host computer using the first and/or second and/or third method aspects.

The processing circuitry of the host computer may be configured to execute a host application, thereby providing the data (e.g., the paging message) and/or any host computer functionality described herein. Alternatively, or in addition, the processing circuitry of the UE may be configured to execute a client application associated with the host application.

Any one of the (e.g., remote or relay) devices, the (e.g., remote or relay) UEs, the network node (e.g., base station), the communication system or any node or station for embodying the technique may further include any feature disclosed in the context of the method aspect, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for relaying a paging message from a network node through a relay radio device to a remote radio device, which may be embodied by the relay radio device;

FIG. 2 shows a schematic block diagram of an embodiment of a device for relaying a paging message from a network node through a relay radio device to a remote radio device, which may be embodied by the remote radio device;

FIG. 3 shows a schematic block diagram of an embodiment of a device for relaying a paging message from a network node through a relay radio device to a remote radio device, which may be embodied by the network node;

FIG. 4 shows a flowchart for a method of relaying a paging message from a network node through a relay radio device to a remote radio device, which method may be implementable by the device of FIG. 1;

FIG. 5 shows a flowchart for a method of relaying a paging message from a network node through a relay radio device to a remote radio device, which method may be implementable by the device of FIG. 2;

FIG. 6 shows a flowchart for a method of relaying a paging message from a network node through a relay radio device to a remote radio device, which method may be implementable by the device of FIG. 3;

FIG. 7 schematically illustrates a first example of a radio network comprising embodiments of the devices of FIGS. 1, 2, and 3 for performing the methods of FIGS. 4, 5, and 6, respectively;

FIG. 8 schematically illustrates a signaling diagram resulting from embodiments of the devices of FIGS. 1, 2, and 3 performing the methods of FIGS. 4, 5, and 6, respectively, in radio communication;

FIG. 9 schematically illustrates an example for consumption of power and radio resources associated with a paging early indication (PEI) occasion and a paging occasion (PO), which may be applied in any embodiment;

FIG. 10 schematically illustrates a first example of a PEI occasion and an associated PO, which may be used in any embodiment;

FIG. 11 schematically illustrates a second example of PEI occasions and associated POs, which may be used in any embodiment;

FIG. 12 schematically illustrates a first example of communication protocols, which may be used in any embodiment for the relaying of the paging message;

FIG. 13 schematically illustrates a second example of communication protocols, which may be used in any embodiment for the relaying of the paging message;

FIG. 14 schematically illustrates a second example of a radio network comprising radio interfaces for the radio communication of embodiments of the devices of FIGS. 1, 2, and 3 for performing the methods of FIGS. 4, 5, and 6, respectively;

FIG. 15 schematically illustrates a third example of communication protocols, which may be used in any embodiment for the relaying of the paging message;

FIG. 16 shows a schematic block diagram of a relay radio device embodying the device of FIG. 1;

FIG. 17 shows a schematic block diagram of a remote radio device embodying the device of FIG. 2;

FIG. 18 shows a schematic block diagram of a network node (e.g., a radio access network) embodying the device of FIG. 3;

FIG. 19 schematically illustrates an example telecommunication network connected via an intermediate network to a host computer;

FIG. 20 shows a generalized block diagram of a host computer communicating via a base station or radio device functioning as a gateway with a user equipment over a partially wireless connection; and

FIGS. 21 and 22 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

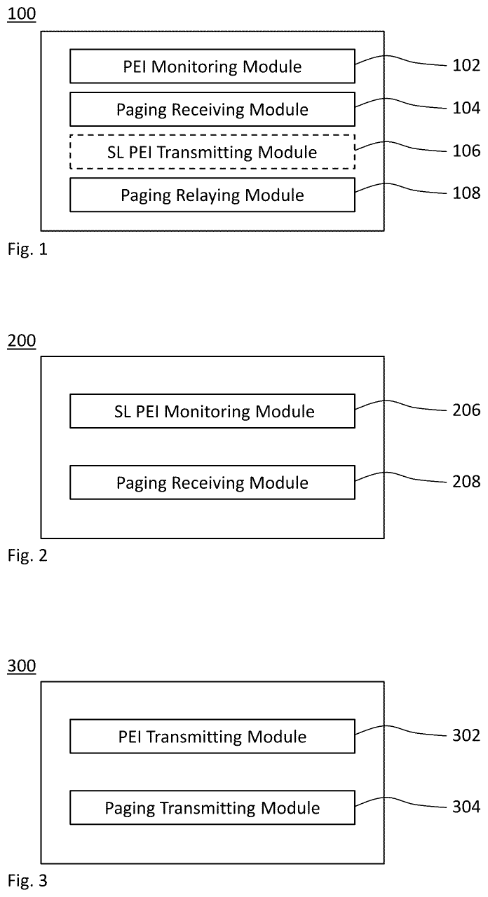

FIG. 1 schematically illustrates a block diagram of an embodiment of a device for relaying a paging message from a network node through a relay radio device to a remote radio device. The device is generically referred to by reference sign 100.

The device 100 comprises a module 102 for selectively announcing a paging message by (e.g., receiving) a paging early indication (PEI) on a downlink (DL) from a network node at the relay radio device depending on whether the relay radio device supports receiving of the PEI and/or independent of whether the remote radio device supports receiving of the PEI.

The device 100 further comprises a module 104 that receives the paging message on the DL from the network node at the relay radio device.

The device 100 comprises a module 108 that relays the received paging message on a sidelink (SL) from the relay radio device to the remote radio device.

Optionally, the device 100 further comprises a module 106 (e.g., a sub-module of the module 102) that transmits a PEI or forwards the PEI in the SL from the relay radio device.

Any of the modules of the device 100 may be implemented by units configured to provide the corresponding functionality.

The device 100 may also be referred to as, or may be embodied by, the relay radio device (or briefly: relay UE). The relay radio device 100 and the network node and/or the relay radio device 100 and the remote radio device may be in direct radio communication, e.g., at least for the selectively announcing the paging message and/or relaying the paging message.

FIG. 2 schematically illustrates a block diagram of an embodiment of a device for relaying a paging message from a network node through a relay radio device to a remote radio device. The device is generically referred to by reference sign 200.

The device 200 comprises a module 206 for selectively announcing a paging message by (e.g., receiving) a SL paging early indication (PEI) on a sidelink (SL) from the relay radio device at the remote radio device depending on whether the remote radio device supports receiving of the SL PEI and/or independent of whether the relay radio device supports receiving of a PEI from the network node.

The device 200 comprises a module 208 that receives the paging message on a sidelink (SL) from a relay radio device at the remote radio device in a SL paging occasion (PO) of the remote radio device.

Any of the modules of the device 200 may be implemented by units configured to provide the corresponding functionality.

The device 200 may also be referred to as, or may be embodied by, the remote radio device (or briefly: remote UE). The remote radio device 100 and the relay radio device may be in direct radio communication, e.g., at least for the selectively announcing of the paging message and/or for the relaying of the paging message.

FIG. 3 schematically illustrates a block diagram of an embodiment of a device for relaying a paging message from a network node through a relay radio device to a remote radio device. The device is generically referred to by reference sign 300.

The device 300 comprises a module 302 for selectively announcing a paging message by (e.g., transmitting) a paging early indication (PEI) on a downlink (DL) from the network node to the relay radio device depending on whether the relay radio device supports the receiving of the PEI and/or independent of whether the remote radio device supports the receiving of the PEI.

The device 300 further comprises a module 304 that transmits the paging message on the DL from the network node to the relay radio device for relaying the transmitted paging message on a sidelink (SL) from the relay radio device to the remote radio device.

Any of the modules of the device 300 may be implemented by units configured to provide the corresponding functionality.

The device 300 may also be referred to as, or may be embodied by, the network node (or briefly: gNB). The network node 300 and the relay radio device may be in direct radio communication, e.g., at least for the selectively announcing of the paging message and/or relaying of the paging message.

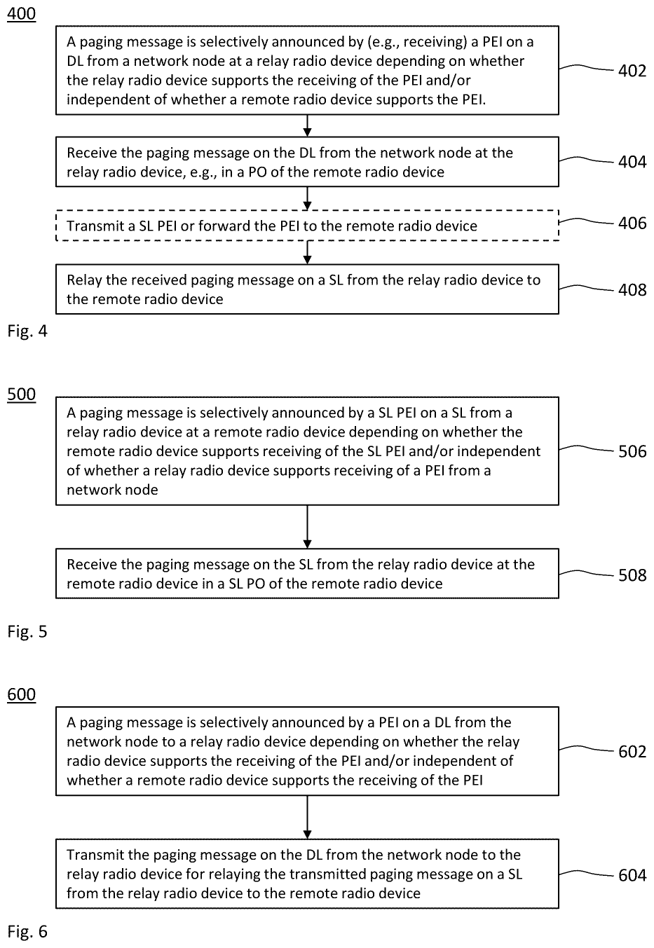

FIG. 4 shows an example flowchart for a method 400 according to the first method aspect and/or the embodiment 1 in the list of embodiments.

The method comprises the steps 402, 404, and 408 (and optionally 406) indicated in FIG. 4 and/or according to the first method aspect.

The method 400 may be performed by the device 100. For example, the modules 102, 104, 106, and 108 may perform the steps 402, 404, 406, and 408, respectively.

FIG. 5 shows an example flowchart for a method 500 according to the second method aspect and/or the embodiment 20 in the list of embodiments.

The method comprises the steps 506 and 508 indicated in FIG. 5 and/or according to the second method aspect.

The method 500 may be performed by the device 200. For example, the modules 206 and 208 may perform the steps 506 and 508, respectively.

FIG. 6 shows an example flowchart for a method 600 according to the third method aspect and/or the embodiment 22 in the list of embodiments.

The method comprises the steps 602 and 604 indicated in FIG. 6 and/or according to the third method aspect.

The method 600 may be performed by the device 300. For example, the modules 302 and 304 may perform the steps 602 and 604, respectively.

In any aspect, the technique may be applied to uplink (UL), downlink (DL) or direct communications between radio devices, e.g., device-to-device (D2D) communications or sidelink (SL) communications.

Idle mode may be a mode of the remote and/or relay radio device within a (e.g., radio resource control, RRC) disconnected state. Alternatively or in addition, connected mode (or active mode) and/or the inactive mode may be modes of the remote and/or relay radio device within a (e.g., RRC) connected state.

Alternatively or in addition, the RRC idle mode (or RRC_IDLE mode) may also be referred as RRC idle state (or RRC_IDLE state). The RRC inactive state (or RRC_INACTIVE mode) may also be referred to as RRC inactive state (or RRC_INACTIVE state).

Each of the relay device 100 and remote radio device 200 may be a radio device (UE). The network node 300 may be a base station.

Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

Herein, whenever referring to noise or a signal-to-noise ratio (SNR), a corresponding step, feature or effect is also disclosed for noise and/or interference or a signal-to-interference-and-noise ratio (SINR).

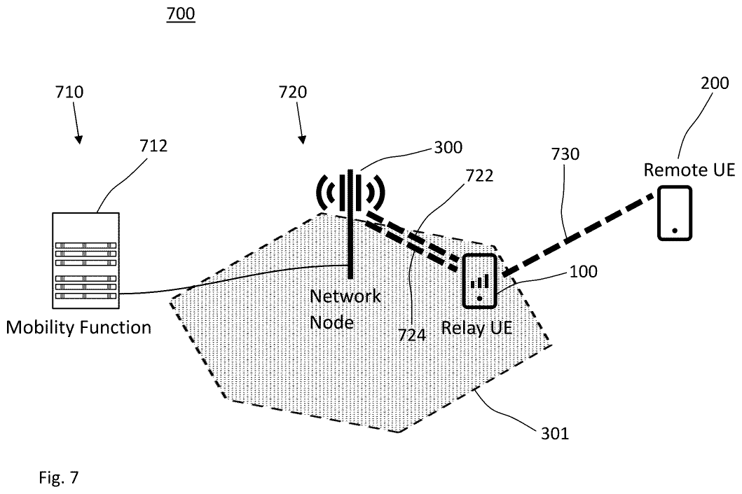

FIG. 7 schematically illustrates a first example of a radio network 700 comprising embodiments of the relay radio device 100, the remote device 200, and the network node 300 for performing the methods 400, 500, and 600, respectively;

The network node 300 is part of a radio access network (RAN) 720 and provides radio access at least to the relay radio device 100 in at least one cell 301. The radio access may comprise a downlink (DL) 722 and an uplink (UL) 724.

The relay radio device 100 is in radio communication with the remote radio device 200 over at least one sidelink 730 (optionally multiple hops).

A core network (CN) 710 serves the RAN 720. The CN 720 comprise mobility function (e.g., a mobility management entity, MME, or an access and mobility function, AMF).

Any embodiment and any aspect may use at least one of the following features and steps for paging (i.e., transmitting and/or receiving the paging message) in sidelink relay.

For concreteness and not limitation, the network node is referred to as a gNB, and the radio devices are referred to as UEs. The paging message is also referred to as paging.

When the remote UE 200 is in RRC_IDLE or RRC_INACTIVE state and there is incoming DL traffic for the remote UE 200, the network node 300 will page the remote UE 200. The relay UE (e.g., a L2 UE-to-NW relay) supports forwarding of paging for the remote UE 200.

In LTE multiple possible paging options with which the remote UE in RRC_IDLE can be reachable are investigated (e.g., according to the 3GPP document TR 36.746), and it was agreed in the group RAN2 at 3GPP that the paging Option 2 is selected as a baseline for paging relaying for NR (e.g., for L2 UE-to-NW relay 100).

The relaying may use at least one of the features and steps described below and/or described for paging option 2 in the 3GPP TR 36.746.

The evolved L2 ProSe UE-to-Network Relay UE 100 monitors its linked evolved ProSe Remote UE's PO in addition to its own PO. The evolved ProSe Remote UE does not need to attempt paging reception over downlink while linked to the evolved L2 ProSe UE-to-Network Relay UE. The evolved L2 ProSe UE-to-Network Relay UE may need to monitor multiple paging occasions. The evolved L2 ProSe UE-to-Network Relay UE has to know the paging occasion of the evolved ProSe Remote UE and has to decode a paging message and determine which evolved ProSe Remote UE the paging is for. Also, the evolved L2 ProSe UE-to-Network Relay UE may need to relay the evolved ProSe Remote UE's paging over short range link.

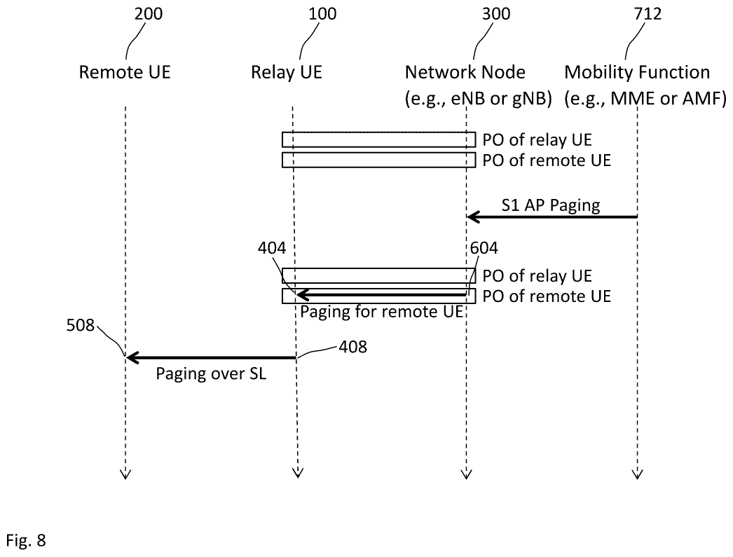

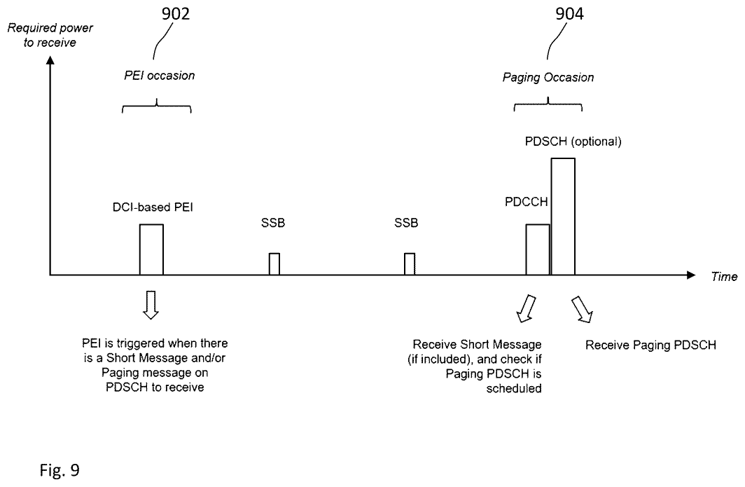

This relaying is schematically illustrated in the signaling diagram of FIG. 8, e.g. for paging using evolved ProSe Remote UE (Option 2).

This paging relaying can have at least one of the following advantages:
It is commonly applicable to both when the evolved ProSe Remote UE is in and out of E-UTRAN coverage;
The evolved ProSe Remote UE does not need to attempt paging reception over DL while linked to the evolved ProSe UE-to-Network Relay UE. This is more power efficient for the evolved ProSe Remote UE; and
No need for network to know whether the evolved ProSe Remote UE and the evolved ProSe UE-to-Network Relay UE are linked or associated.

At least some embodiments can overcome at least one of the following disadvantages:
The evolved ProSe UE-to-Network Relay UE needs to monitor multiple POs. This is less power efficient for the evolved ProSe UE-to-Network Relay UE as the power consumption may increase depending on the number of evolved ProSe Remote UEs linked to the evolved ProSe UE-to-Network Relay UE; and
The evolved ProSe UE-to-Network Relay UE needs to relay evolved ProSe Remote UE's paging over short range link. This causes additional power consumption for the evolved ProSe UE-to-Network Relay UE and additional use of SL

Any embodiment and any aspect may implement at least one of the following features and steps for the Paging Early Indication (PEI).

The Third Generation Partnership Project (3GPP) introduced a paging early indication (PEI, e.g. comprised in a PEI message) for Fifth Generation (5G) New Radio (NR) to enable a further power saving of the UE when the UE is monitoring paging in the idle mode or the inactive mode. The PEI in NR is similar as the Wake-Up Signal (WUS) in 3GPP Long Term Evolution (LTE), which enables the UE to increase the standby time. The main power consumption of the UE in idle mode or (e.g., RRC) inactive state comes from having to wake up every discontinuous reception (DRX) cycle to potentially receive a paging message on the PDSCH.

FIG. 9 schematically illustrates a temporal and causal relation between a paging early indication (PEI) occasion 902 and a paging occasion (PO, i.e., a paging message occasion) 904.

The UE 100 or 200 consumes less power to receive a paging physical downlink control channel (PDCCH) compared to a paging physical downlink shared channel (PDSCH). The PEI message may be a short PDCCH message.

When the UE 100 wakes-up during a paging occasion (PO), the UE 100 first receives the paging PDCCH which may include a Short Message. When scheduled, the Short Message may indicate a change in system information (SI), a message of an Earthquake and Tsunami Warning System (ETWS) or a Commercial Mobile Alert System (CMAS) or a Stop Monitoring Paging (shared spectrum with repetitions).

The paging PDCCH may also indicate whether there is a paging message on PDSCH. There is (typically) no Cross Slot Scheduling (CSS) with Paging, i.e. no time between the Paging PDCCH and PDSCH. This means that when the UE wakes-up during a Paging Occasion the UE needs to be prepared to receive a Paging PDSCH, even when in most cases there is no Paging PDSCH. For estimating an expected power saving (e.g., according to a power saving model the RAN1 group at 3GPP), it may be assumed that there is a paging PDSCH only in 10% of the POs.

PEI is an optional UE feature for 3GPP Release 17 of New Radio (NR). Details of the UE capability to support PEI have been partially specified by the group RAN1 at 3GPP. Further aspects, e.g. with or without capability signaling, are open for discussion in the group RAN2 of 3GPP.

For inter-operability between UE and gNB, the gNB needs to know whether the UE uses PEI when monitoring paging. If the UE monitored PEI but the gNB did not transmit the PEI, the UE would not wake up during the following PO. From a network perspective, it is also essential in terms of power saving and radio resource efficiency that the PEI is only transmitted when the UE uses (i.e., monitors) the UE.

The UE 100 and/or 200 may signal its PEI capability (e.g., whether the UE supports PEI) to the gNB 300. For example, the UE should signal support for PEI in the information element (IE) UERadioPagingInfo in the UECapabilityInformation message. The radio paging capabilities of the UE 100 and/or 200 are included in the paging message from a core network (CN, e.g., from an Access and Mobility management Function, AMF) to the gNB 300, e.g. in case of connection management idle paging (or CM-IDLE paging), i.e. when the UE 100 and/or 200 is in RRC_IDLE mode.

Furthermore, the radio paging capabilities of the UE 100 and/or 200 may be included in a control plane message, e.g. to setup the UE context, such as an initial context setup request message from the AMF to the gNB. This enables the gNB to know if the paged UE supports PEI in case the gNB (or the radio access network, RAN, comprising the gNB) pages the UE in the RRC_INACTIVE state. The control plane message may be an “INITIAL CONTEXT SETUP REQUEST” message according to an application protocol for the interface NG3 and/or the 3GPP document TS 38.413, version, clause 9.2.2.1.

Moreover, the gNB 300 may signal whether the gNB supports PEI to the UE. For example, the gNB may broadcast whether the gNB supports PEI in system information (SI). When the gNB indicated PEI support in SI and there is a change of the SI or an ETWS or CMAS message, the gNB will transmit the PEI for all the POs during a DRX cycle.

In the 3GPP document TS 38.304, version 16.6.0, it is specified how the UE 100 and/or 200 finds its paging occasion (PO) to monitor based on the UE identity and the DRX cycle used in RRC_IDLE and/or RRC_INACTIVE. The 3GPP document TS 38.304 may specify where the UE 100 and/or 200 can find the PEI occasion associated with the PO. Dependent on the PEI configuration, a single PEI occasion can tell the UE to monitor 1 or more POs (i.e. 1:N mapping of PEI to PO). The time period between PEI occasion and (first) PO is configurable in system information (SI).

The UE 100 and/or 200 monitors a single PO during a DRX cycle. When the gNB 300 receives a paging message to transmit to the UE, the gNB will transmit the paging message in the next PO of that UE. However, if PEI is used, an additional latency of at least one DRX cycle is incurred when the Paging message is received in the time period between the PEI occasion and the (e.g., first) PO.

Any embodiment and any aspect may use paging subgroups (e.g., to reduce false paging alarms) according to at least one of the following features or steps.

There can be two reasons why a UE receives a paging message on PDSCH which is not for that UE (in which case the UE discards the paging message):
1. The paging message is for another UE monitoring the same PO
2. The paging message is for another UE that the network is trying to reach, but this UE is not monitoring this PO (i.e. not camped on this cell).

Case 1 happens more often when there are a lot of UEs camped on the cell and/or there is a limited Paging capacity configured in the cell. The UEs in the cell are pseudo randomly distributed over the configured POs per DRX cycle based on the UE identity. At most, the network can configure each frame as a Paging Frame (PF) and up to 4 POs per PF.

Case 2 happens more often when the UEs are moving a lot, and the network does not reach the UE in the first paging attempt and escalates the paging to a wider area to find the UE. Typically the network first pages the UE in the “last used” cell, i.e. the cell where the UE was in connected mode the last time. If the UE does not respond to that paging attempt, because it has moved, the network escalates the paging to a wider area (e.g. complete TAI-list). The UE will be paged in many cells in such case, but only respond in one of them (in best case). And for all the cells where the UE does not respond in (because the UE are not in any of those cells) means that potentially other UEs in those cells may be receive a paging message hence unnecessarily waking them up.

A paging message can include paging records indicating which UEs are paged and there can be up to 32 paging records, i.e. up to 32 different UEs can be paged in the same paging message.

When the UE receives a paging message that is not for that UE, this is called a “false alarm”.

The UEs (e.g., served by the same gNB) may be divided into multiple paging subgroups (or briefly: subgroups). By indicating to the UE which subgroup is paged, the number (or rate) of false alarms can be reduced. False alarms are not completely prevented, i.e. it is still possible that the UE receives a paging message for another UE in the same paging subgroup, but the false alarm rate is reduced, e.g. with 4 paging subgroups the false alarm rate is reduced to 25% (on average).

Subgroup information may be added to the PEI, i.e. it is an optional feature in addition to PEI (e.g., in a PEI message comprising both the PEI and, optionally, the subgroup information). If the PEI does not include (i.e., is not indicative of) the paging subgroup of the UE, the UE will not monitor the following PO.

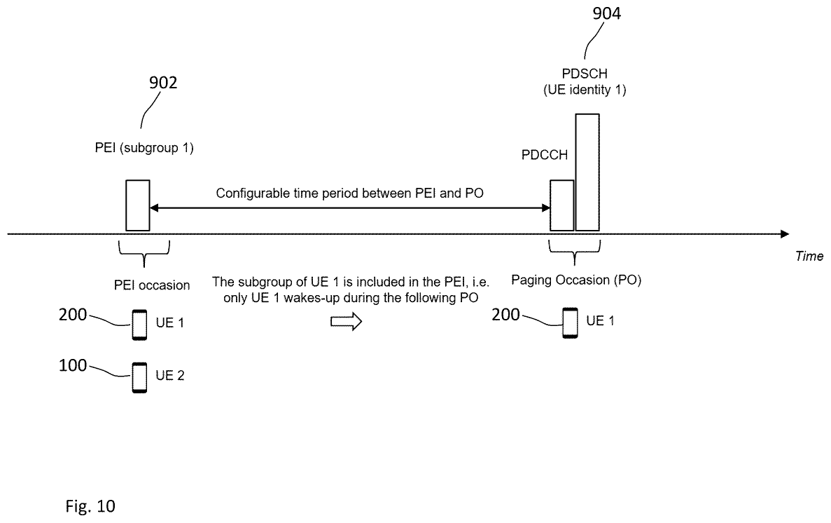

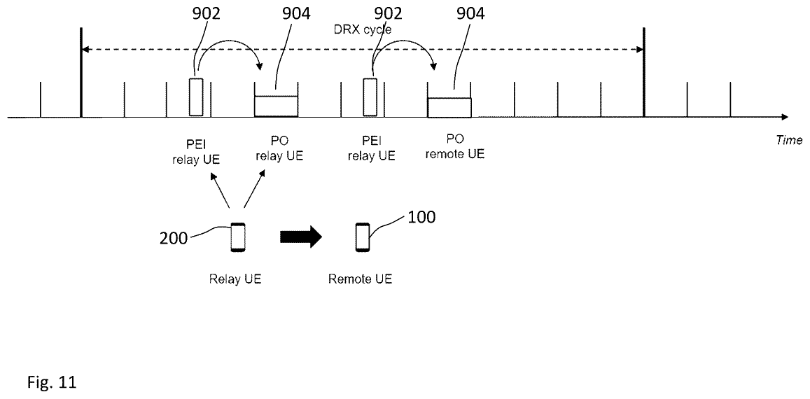

FIG. 10 schematically illustrates selectively waking up UEs by differentiating between the UEs using a subgroup indicated in the PEI.

Paging subgroups can further reduce the power consumption in the idle mode or the (e.g., RRC) inactive state mode, but the main reduction comes from monitoring PEI rather than the associated paging message, because the UE in most cases is not paged when it wakes-up

Two different paging subgroup methods are supported, i.e. how to assign a subgroup to the UE 100 and/or 200:
UE-ID based: based on the UE identity, the UE 100 and/or 200 is assigned to a subgroup (similar as with PO selection). This assignment method is also random as the UE identity is random.
CN-assigned: during registration, the CN 710 assigns a subgroup to the UE 100 and/or 200 based on the UE characteristics (e.g. UE type, UE paging probability, etc.).

In system information (SI), the gNB 300 may indicate using subgroups, i.e. that the PEI is indicative of a subgroup. Alternatively or in addition, the SI may indicate that the subgroup is based on a UE-ID (which may also be referred to as UE-ID based grouping). Alternatively or in addition, the SI may indicate that the subgroup is assigned by the CN (which may also be referred to as CN-assigned grouping). Alternatively or in addition, the SI may indicate that both methods (i.e., UE-ID based grouping and CN-assigned grouping) are used. For example, when the UE did not get a subgroup (e.g., a subgroup assigned by the CN) during registration, the UE uses a subgroup based on its UE-ID.

In CN-assigned subgrouping, the subgrouping is left to the network implementation. The gNB allocates the UE with a subgroup ID before the UE enters idle mode or inactive state (e.g. the subgroup ID of a UE can be signaled in the RRC release message to the UE). The network stores the subgroup ID in the CN for an RRC Idle UE; this is done by gNB 300 providing it to the CN for storage. In case of RRC inactive mode, the gNB 300 stores the subgroup ID of a UE 100 and/or 200 as part of the UE context.

Paging subgrouping is an optional feature for the UE 100 and/or 200, and the UE 100 and/or 200 can support UE-ID (e.g., as an access stratum, AS, capability) and CN-assigned based grouping (e.g., as a non-access stratum, NAS, capability) separately. The AMF 712 includes the CN-assigned subgroup ID in the paging message sent from AMF 712 to gNB 300.

At least some embodiments, e.g., according to the methods 400, 500, and/or 600, can cause (e.g., the network node 300), in contrast to the prior art behavior indicated in the introduction, the following behavior (differences are emphasized).

| | | Relay UE does not |
|---|---|---|
| | Relay UE supports PEI | support PEI |
| Remote UE | PEI is applied for relay | No PEI is applied for relay |
| supports PEI | UE paging | UE paging |
| | PEI is applied for remote | No PEI is applied for |
| | UE paging | remote UE paging |
| Remote UE does | PEI is applied for relay | No PEI is applied for relay |
| not support PEI | UE paging | UE paging |
| | PEI is applied for remote | No PEI is applied for |
| | UE paging | remote UE paging |

In one detailed embodiment, a network node 300 would, when it pages a UE 100 which is currently in a state where it reads its own paging directly (e.g. the UE 100 is not a remote UE 200), consider that UE's capabilities with regards to PEI when the network node 300 sends paging for the UE 100 in the step 604. Or in other words, the network node 300 would send PEI in the step 602 if the UE 100 is capable of (and configured to use) PEI.

However, if the UE 200 is in a state where it receives its paging via another UE 100 (e.g., the UE 200 is a remote UE 200 served by a relay UE 100), the network node 300 would consider the other UE's capabilities (e.g., of the relay UE 100) with regards to PEI when the network node sends paging for the UE in the steps 602 and 604. Or in other words, the network node would send PEI according to the step 602 when it pages a remote UE 200 if the relay UE 100 supports (and is configured to use) PEI.

In one detailed embodiment, if a relay UE 100 receives PEI when monitoring its own paging occasions (POs, e.g., PEI occasions 902), the relay UE 100 consider this PEI as it is common for itself and for the remote UE 200. This means that the relay UE 100 will start to monitor its own POs 904 and the POs 904 of the remote UE 200 for receiving a paging message in the step 404.

Alternatively, in other detailed embodiment, if a relay UE 100 receives PEI when monitoring its own paging occasions (POs), the PEI may carry an indication on whether this PEI is for the relay UE 100, remote UE 200, or both.

Yet, in another detailed embodiment, a relay UE 100 may understand whether the received PEI is for itself or for the remote UE 200 based on whether this PEI is received when monitoring relay UE POs or remote UE POs (i.e., if PEI is received on remote UE POs then the PEI is for remote UE and if PEI is received on the relay UE POs then the PEI is for the relay UE).

In another detailed embodiment, regardless on whether the remote UE supports PEI or not, when a relay UE 100 receives a PEI that is for the remote UE 200, it sends 406 a signaling to the remote UE 200 so to alert the remote UE 200 that a paging message is about to come. This wake-up signaling (e.g., a SL PEI) from the relay UE 100 to the remote UE 200 is useful in case the remote UE 200 is following a SL DRX that is not aligned with a paging DRX (e.g., meaning that the relay UE 100 may eventually send 408 the paging message to the remote UE 200 without considering the paging DRX or SL DRX but rather when this is received by the network—the remote UE is woken up when necessary).

Basically, what is meant with this detailed embodiment is that this “wake-up signal” over the sidelink 730 may be sent regardless of the paging DRX or SL DRX (since this signal wake up the UE basically on-demand) configured at the remote UE 200.

In one detailed embodiment, if both the remote UE 200 and relay UE 100 support PEI, every time that the relay UE 100 receives a PEI that is for the remote UE 200, the relay UE 100 simply forwards the short message (in which the PEI in included) to the remote UE 200.

In another detailed embodiment, the signaling between UEs 100 and 200 can be sent in at least one of these options:
RRC signaling (e.g., PC5-RRC);
PC5-S signaling;
Discovery signaling;
Medium Access Control (MAC) Control Element (CE);
Control PDU of a protocol layer (e.g., SDAP, PDCP, RLC, or an adaptation layer in case of SL relay); and
L1 signaling on channels such as PSSCH, PSCCH, or PSFCH.

In another detailed embodiment, when paging subgroups are used, and the relay UE 100 only monitors its own PEI occasion (e.g., and not the PEI occasion of the remote UE 200), the gNB 300 includes the subgroup information of the remote UE 200 in the PEI occasion of the relay UE 100.

In another detailed embodiment, when paging subgroups are used, and the relay UE 100 monitors both its own PEI occasion and the PEI occasion of the remote UE 200, the gNB 300 includes the subgroup info of the remote UE 200 and/or the relay UE 100 in the PEI occasion of the remote UE 200 and/or the relay UE 100.

In another detailed embodiment, when paging subgroups are used, and the relay UE 100 only monitors its own PEI occasion and the gNB 300 includes an indication in the PEI whether relay UE 100 and/or remote UE 200 are paged, the gNB 300 includes the subgroup information of the remote UE 200 in the PEI occasion of the relay UE 100.

As pointed out in the introduction, when the UE 100 and/or 200 is paged, the gNB 300 needs to know if the paged UE 100 and/or 200 supports PEI. In case the relay UE 100 is used, the gNB 300 needs to know if the relay UE 100 supports PEI. In one embodiment, the UE capability to support relay needs to be added to the UERadioPagingInfo IE in the UECapabilityInformation message.

Any transmission (e.g., in at least one of the steps 406, 408, 506, and 508) on the sidelink (SL) 730 in NR may use at least one of the following features and steps.

Sidelink transmissions over NR are specified for 3GPP Release 16. These are enhancements of the ProSe (PROximity-based SErvices) specified for 3GPP LTE. Four new enhancements are particularly introduced to NR sidelink transmissions as follows:
Support for unicast and groupcast transmissions are added in NR sidelink. For unicast and groupcast, the physical sidelink feedback channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of Physical Sidelink Control Channel (PSCCH).
To achieve a high connection density, congestion control and thus the Qos management is supported in NR sidelink transmissions.

To enable the above enhancements, al teas one of the following SL-dedicated physical channels and/or reference signals may be used (e.g., in NR or LTE):
PSSCH (Physical Sidelink Shared Channel, SL version of PDSCH): The PSSCH is transmitted by a sidelink transmitter UE, which conveys sidelink transmission data, system information blocks (SIBs) for radio resource control (RRC) configuration, and a part of the sidelink control information (SCI).
PSFCH (Physical Sidelink feedback channel): The PSFCH is transmitted by a sidelink receiver UE for unicast and groupcast, which conveys 1 bit information over 1 RB for the HARQ acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver UE arrives at a transmitter UE, a transmitter UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

Another feature is the two-stage sidelink control information (SCI). This a version of the DCI for SL. Unlike the DCI, only part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining (second stage) scheduling and control information such as a 8-bits source identity (ID) and a 16-bits destination ID, NDI, RV and HARQ process ID is sent on the PSSCH to be decoded by the receiver UE.

Similar as for PROSE in LTE, NR sidelink transmissions have the following two modes of resource allocations:
Mode 1: Sidelink resources are scheduled by a gNB.
Mode 2: The UE autonomously selects sidelink resources from a (pre-) configured sidelink resource pool(s) based on the channel sensing mechanism.

For the in-coverage UE, the gNB may be configured to adopt (e.g., apply) Mode 1 or Mode 2. For the UE being out-of-coverage, the gNB may adopt (e.g., apply) only Mode 2.

As in LTE, scheduling over the sidelink (SL) in NR is done in different ways for Mode 1 and Mode 2.

The Mode 1 may support at least one of a dynamic grant and a configured grant:

Dynamic grant: When the traffic to be sent over sidelink arrives at a transmitter UE, this UE should launch the four-message exchange procedure to request sidelink resources from a gNB (SR sent on UL by the UE to the network, UL grant sent by the network to the UE, Sidelink BSR send on UL by the UE to the network, Sidelink grant for data on SL sent by the network to the UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with CRC scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB. As a result, this kind of grant is suitable for traffic with a loose latency requirement.

Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI.

When a transmitter UE launches the PSCCH, CRC is also inserted in the SCI without any scrambling.

In the Mode 2 resource allocation, when traffic arrives at a transmitter UE, this transmitter UE should autonomously select resources for the physical sidelink control channel (PSCCH) and the physical sidelink shared channel (PSSCH). To further minimize the latency of the feedback HARQ ACK/NACK transmissions and subsequently retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE 100, then this transmitter UE 100 should select resources for at least one of the following transmissions: A first transmission on the PSSCH associated with the PSCCH for initial transmission and blind retransmissions. A second transmission on the PSSCH associated with the PSCCH for retransmissions.

Since each transmitter UE 100 in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH depending on the configuration. This information is known only after receiver SCI launched by (all) other UEs. The sensing and selection algorithm may be rather complex.

Any embodiment may implement the relay UE 100 as a Layer 2 (L2) UE-to-Network relay.

In the 3GPP document TR 23.752, clause 6.7, the layer-2 based UE-to-Network relay is described.

The protocol architecture supporting a L2 UE-to-Network Relay UE is provided. The L2 UE-to-Network Relay UE provides forwarding functionality that can relay any type of traffic over the PC5 link.

The L2 UE-to-Network Relay UE provides the functionality to support connectivity to the 5GS for Remote UEs. A UE is considered to be a Remote UE if it has successfully established a PC5 link to the L2 UE-to-Network Relay UE. A Remote UE can be located within NG-RAN coverage or outside of NG-RAN coverage.

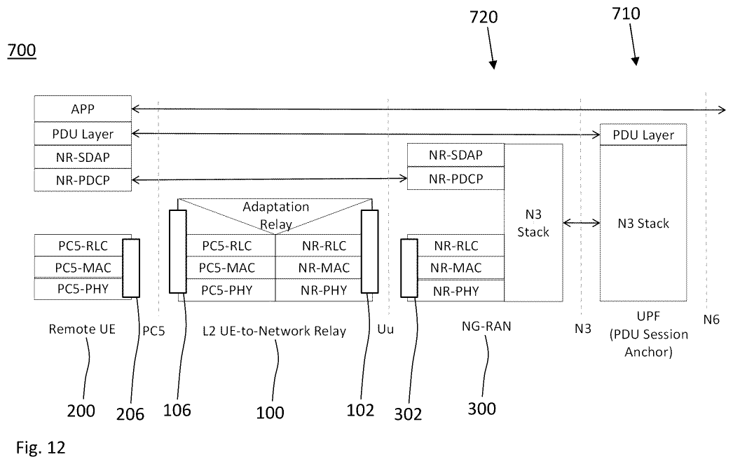

FIG. 12 illustrates the protocol stack for the user plane transport, related to a PDU Session, including a Layer 2 UE-to-Network Relay UE. The PDU layer corresponds to the PDU carried between the Remote UE and the Data Network (DN) over the PDU session. The PDU layer corresponds to the PDU carried between the Remote UE and the Data Network (DN) over the PDU session. It is important to note that the two endpoints of the PDCP link are the Remote UE and the gNB. The relay function is performed below PDCP. This means that data security is ensured between the Remote UE and the gNB without exposing raw data at the UE-to-Network Relay UE.

FIG. 12 illustrates a User Plane Stack for L2 UE-to-Network Relay UE 100, e.g., according to the 3GPP document TR 23.752.

The adaptation relay layer within the UE-to-Network Relay UE can differentiate between signaling radio bearers (SRBs) and data radio bearers (DRBs) for a particular Remote UE. The adaption relay layer is also responsible for mapping PC5 traffic to one or more DRBs of the Uu. The definition of the adaptation relay layer is under the responsibility of RAN WG2.

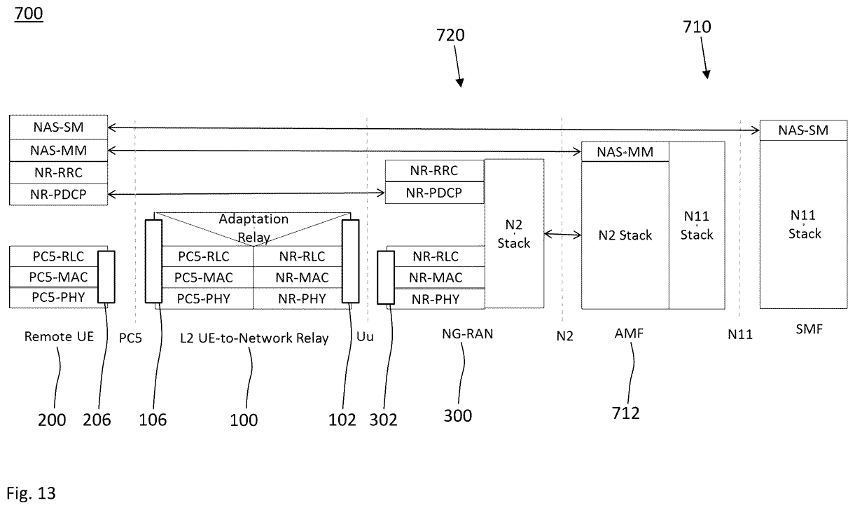

FIG. 13 illustrates the protocol stack of the NAS connection for the remote UE 200 to the NAS-MM and NAS-SM components. The NAS messages are transparently transferred between the Remote UE and 5G-AN over the Layer 2 UE-to-Network Relay UE using:
PDCP end-to-end connection where the role of the UE-to-Network Relay UE is to relay the protocol data units (PDUs) over the signaling radio bear without any modifications.
N2 connection between the 5G-AN and AMF over N2.
N11 connection AMF and SMF over N11.

The role of the UE-to-Network Relay UE 100 is to relay the PDUs from the signaling radio bearer without any modifications.

FIG. 13 schematically illustrates a Control Plane for L2 UE-to-Network Relay UE 100, e.g., according to the 3GPP document in TR 23.752.

Any embodiment may implement the relay UE 100 as a Layer 3 (L3) UE-to-Network relay.

In the 3GPP document TR 23.752, clause 6.6, the layer-3 based UE-to-Network relay is described.

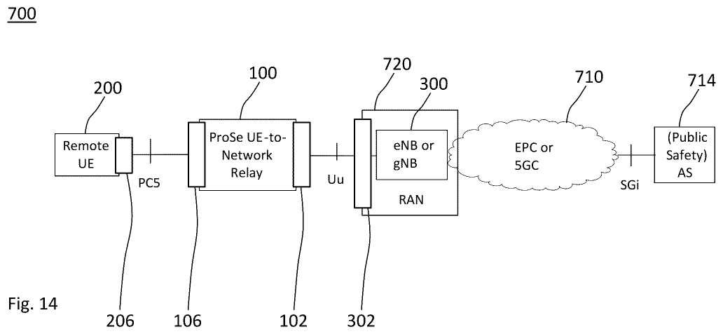

The ProSe 5G UE-to-Network Relay entity 100 provides the functionality to support connectivity to the network for remote UEs 200 (e.g., as illustrated in FIG. 14). It can be used for both public safety services and commercial services (e.g. interactive service).

A UE 200 is considered to be a remote UE 200 for a certain ProSe UE-to-Network relay 100 if it has successfully established a PC5 link to this ProSe 5G UE-to-Network Relay 100. A remote UE 200 can be located within NG-RAN coverage 301 or outside of NG-RAN coverage.

FIG. 14 schematically illustrates an architecture using a ProSe 5G UE-to-Network Relay 100, e.g., according to the 3GPP document TR 23.752.

The ProSe 5G UE-to-Network Relay 100 shall relay unicast traffic (UL 722 and DL 722) between the remote UE 200 and the network node 300. The ProSe UE-to-Network Relay 100 shall provide generic function that can relay any IP traffic.

One-to-one Direct Communication is used between Remote UEs and ProSe 5G UE-to-Network Relays for unicast traffic as specified in solutions for Key Issue #2 in the TR 23.752.

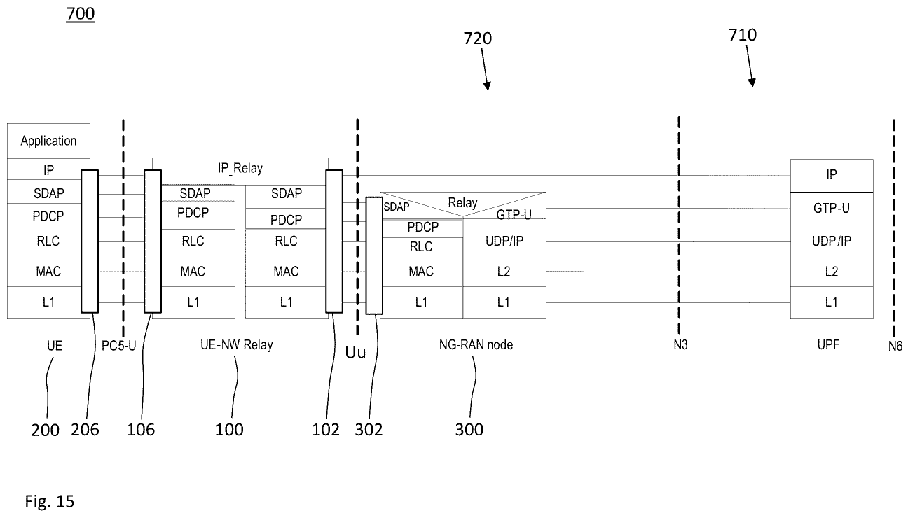

The protocol stack for Layer-3 UE-to-Network Relays is shown in FIG. 15.

FIG. 15 schematically illustrates a protocol stack for ProSe 5G UE-to-Network Relay 100, e.g., according to the 3GPP document TR 23.752.

Hop-by-hop security is supported in the PC5 link and Uu link. If there are requirements beyond hop-by-hop security for protection of Remote UE's traffic, security over IP layer needs to be applied

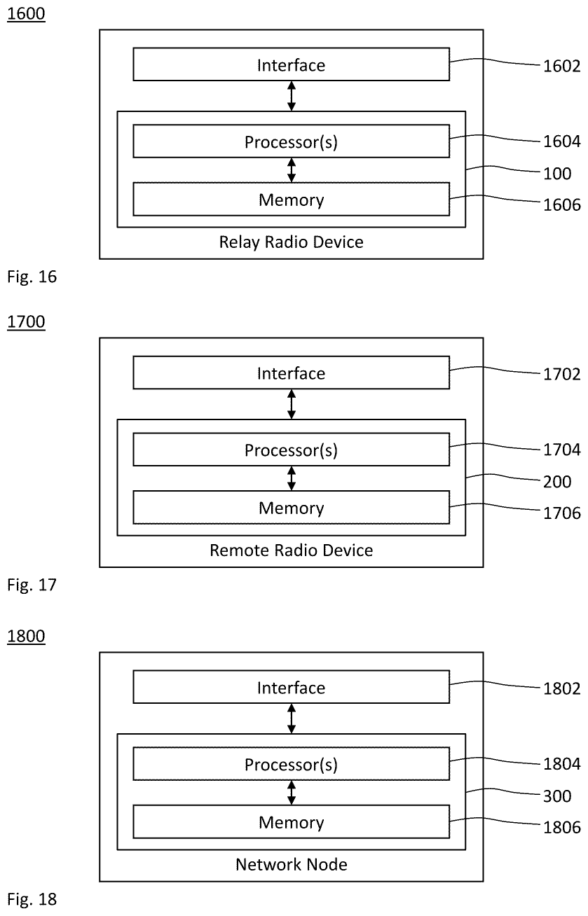

FIG. 16 shows a schematic block diagram for an embodiment of the device 100. The device 100 comprises processing circuitry, e.g., one or more processors 1604 for performing the method 400 and memory 1606 coupled to the processors 1604.

For example, the memory 1606 may be encoded with instructions that implement at least one of the modules 102, 104, 106, and 108.

The one or more processors 1604 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1606, relay radio device functionality. For example, the one or more processors 1604 may execute instructions stored in the memory 1606. Such functionality may include providing various features and steps discussed herein, including any of the benefits disclosed herein. The expression “the device being operative to perform an action” may denote the device 100 being configured to perform the action.

As schematically illustrated in FIG. 16, the device 100 may be embodied by a relay radio device 1600, e.g., functioning as a relay UE. The relay radio device 1600 comprises a radio interface 1602 coupled to the device 100 for radio communication with one or more network nodes and/or remote UEs.

FIG. 17 shows a schematic block diagram for an embodiment of the device 200. The device 200 comprises processing circuitry, e.g., one or more processors 1704 for performing the method 500 and memory 1706 coupled to the processors 1704. For example, the memory 1706 may be encoded with instructions that implement at least one of the modules 206 and 208.

The one or more processors 1704 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1706, remote radio device functionality. For example, the one or more processors 1704 may execute instructions stored in the memory 1706. Such functionality may include providing various features and steps discussed herein, including any of the benefits disclosed herein. The expression “the device being operative to perform an action” may denote the device 200 being configured to perform the action.

As schematically illustrated in FIG. 17, the device 200 may be embodied by a remote radio device 1700, e.g., functioning as a remote UE. The remote radio device 1700 comprises a radio interface 1702 coupled to the device 200 for radio communication with one or more base stations and/or relay UEs.

FIG. 18 shows a schematic block diagram for an embodiment of the device 300. The device 300 comprises processing circuitry, e.g., one or more processors 1804 for performing the method 600 and memory 1806 coupled to the processors 1804. For example, the memory 1806 may be encoded with instructions that implement at least one of the modules 302 and 304.

The one or more processors 1804 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 300, such as the memory 1806, network node functionality. For example, the one or more processors 1804 may execute instructions stored in the memory 1806. Such functionality may include providing various features and steps discussed herein, including any of the benefits disclosed herein. The expression “the device being operative to perform an action” may denote the device 300 being configured to perform the action.

As schematically illustrated in FIG. 18, the device 300 may be embodied by a network node 1800, e.g., functioning as a base station or a gateway UE. The network node 1800 comprises a radio interface 1802 coupled to the device 300 for radio communication with one or more relay UEs.

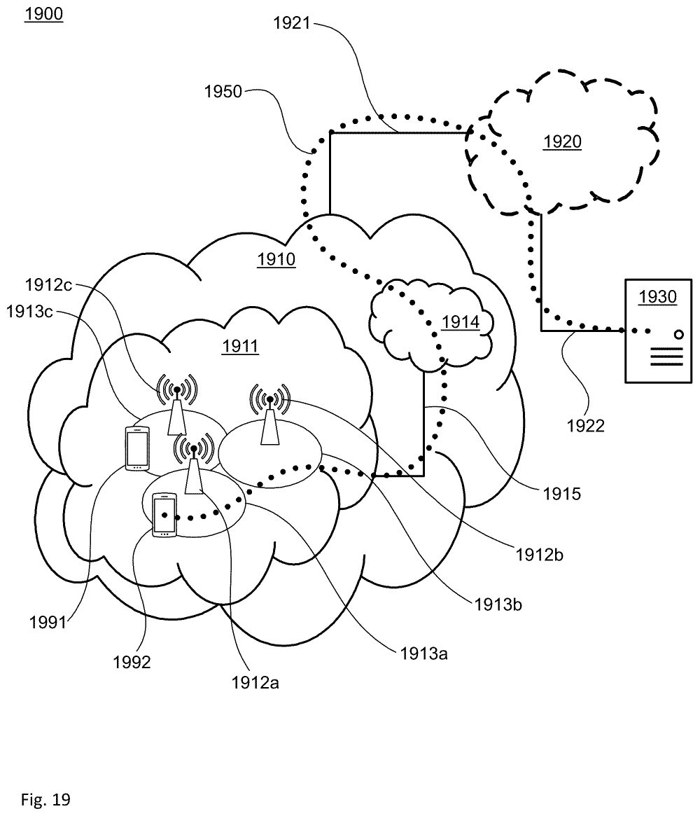

With reference to FIG. 19, in accordance with an embodiment, a communication system 1900 includes a telecommunication network 1910, such as a 3GPP-type cellular network, which comprises an access network 1911, such as a radio access network, and a core network 1914. The access network 1911 comprises a plurality of base stations 1912a, 1912b, 1912c, such as NBs, eNBs, gNBs or other types of wireless access points, each defining a corresponding coverage area 1913a, 1913b, 1913c. Each base station 1912a, 1912b, 1912c is connectable to the core network 1914 over a wired or wireless connection 1915. A first user equipment (UE) 1991 located in coverage area 1913c is configured to wirelessly connect to, or be paged by, the corresponding base station 1912c. A second UE 1992 in coverage area 1913a is wirelessly connectable to the corresponding base station 1912a. While a plurality of UEs 1991, 1992 are illustrated in this example, the disclosed embodiments are equally applicable to a situation where a sole UE is in the coverage area or where a sole UE is connecting to the corresponding base station 1912.

Any of the base stations 1912 and the UEs 1991, 1992 may embody the device 300 and the devices 100 and 200, respectively.

The telecommunication network 1910 is itself connected to a host computer 1930, which may be embodied in the hardware and/or software of a standalone server, a cloud-implemented server, a distributed server or as processing resources in a server farm. The host computer 1930 may be under the ownership or control of a service provider, or may be operated by the service provider or on behalf of the service provider. The connections 1921, 1922 between the telecommunication network 1910 and the host computer 1930 may extend directly from the core network 1914 to the host computer 1930 or may go via an optional intermediate network 1920. The intermediate network 1920 may be one of, or a combination of more than one of, a public, private or hosted network; the intermediate network 1920, if any, may be a backbone network or the Internet; in particular, the intermediate network 1920 may comprise two or more sub-networks (not shown).

The communication system 1900 of FIG. 19 as a whole enables connectivity between one of the connected UEs 1991, 1992 and the host computer 1930. The connectivity may be described as an over-the-top (OTT) connection 1950. The host computer 1930 and the connected UEs 1991, 1992 are configured to communicate data and/or signaling via the OTT connection 1950, using the access network 1911, the core network 1914, any intermediate network 1920 and possible further infrastructure (not shown) as intermediaries. The OTT connection 1950 may be transparent in the sense that the participating communication devices through which the OTT connection 1950 passes are unaware of routing of uplink and downlink communications. For example, a base station 1912 need not be informed about the past routing of an incoming downlink communication with data originating from a host computer 1930 to be forwarded (e.g., handed over) to a connected UE 1991. Similarly, the base station 1912 need not be aware of the future routing of an outgoing uplink communication originating from the UE 1991 towards the host computer 1930.

By virtue of the method 400 and/or 500 being performed by any one of the UEs 1991 or 1992 and/or the method 600 being performed by any one of the base stations 1912, the performance or range of the OTT connection 1950 can be improved, e.g., in terms of increased throughput and/or reduced latency. More specifically, the host computer 1930 may indicate to the network node 300 or the RAN 720 or the relay radio device 100 or the remote radio device 200 (e.g., on an application layer) the QoS of the traffic, which may trigger using the methods 400, 500, and 600.

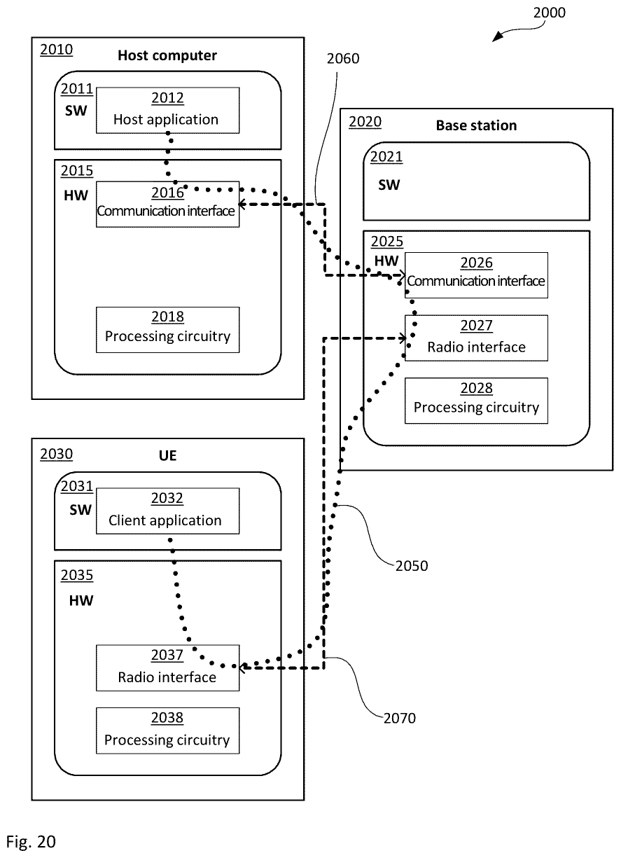

Example implementations, in accordance with an embodiment of the UE, base station and host computer discussed in the preceding paragraphs, will now be described with reference to FIG. 20. In a communication system 2000, a host computer 2010 comprises hardware 2015 including a communication interface 2016 configured to set up and maintain a wired or wireless connection with an interface of a different communication device of the communication system 2000. The host computer 2010 further comprises processing circuitry 2018, which may have storage and/or processing capabilities. In particular, the processing circuitry 2018 may comprise one or more programmable processors, application-specific integrated circuits, field programmable gate arrays or combinations of these (not shown) adapted to execute instructions. The host computer 2010 further comprises software 2011, which is stored in or accessible by the host computer 2010 and executable by the processing circuitry 2018. The software 2011 includes a host application 2012. The host application 2012 may be operable to provide a service to a remote user, such as a UE 2030 connecting via an OTT connection 2050 terminating at the UE 2030 and the host computer 2010. In providing the service to the remote user, the host application 2012 may provide user data, which is transmitted using the OTT connection 2050. The user data may depend on the location of the UE 2030. The user data may comprise auxiliary information or precision advertisements (also: ads) delivered to the UE 2030. The location may be reported by the UE 2030 to the host computer, e.g., using the OTT connection 2050, and/or by the base station 2020, e.g., using a connection 2060.

The communication system 2000 further includes a base station 2020 provided in a telecommunication system and comprising hardware 2025 enabling it to communicate with the host computer 2010 and with the UE 2030. The hardware 2025 may include a communication interface 2026 for setting up and maintaining a wired or wireless connection with an interface of a different communication device of the communication system 2000, as well as a radio interface 2027 for setting up and maintaining at least a wireless connection 2070 with a UE 2030 located in a coverage area (not shown in FIG. 20) served by the base station 2020. The communication interface 2026 may be configured to facilitate a connection 2060 to the host computer 2010. The connection 2060 may be direct, or it may pass through a core network (not shown in FIG. 20) of the telecommunication system and/or through one or more intermediate networks outside the telecommunication system. In the embodiment shown, the hardware 2025 of the base station 2020 further includes processing circuitry 2028, which may comprise one or more programmable processors, application-specific integrated circuits, field programmable gate arrays or combinations of these (not shown) adapted to execute instructions. The base station 2020 further has software 2021 stored internally or accessible via an external connection.

The communication system 2000 further includes the UE 2030 already referred to. Its hardware 2035 may include a radio interface 2037 configured to set up and maintain a wireless connection 2070 with a base station serving a coverage area in which the UE 2030 is currently located. The hardware 2035 of the UE 2030 further includes processing circuitry 2038, which may comprise one or more programmable processors, application-specific integrated circuits, field programmable gate arrays or combinations of these (not shown) adapted to execute instructions. The UE 2030 further comprises software 2031, which is stored in or accessible by the UE 2030 and executable by the processing circuitry 2038. The software 2031 includes a client application 2032. The client application 2032 may be operable to provide a service to a human or non-human user via the UE 2030, with the support of the host computer 2010. In the host computer 2010, an executing host application 2012 may communicate with the executing client application 2032 via the OTT connection 2050 terminating at the UE 2030 and the host computer 2010. In providing the service to the user, the client application 2032 may receive request data from the host application 2012 and provide user data in response to the request data. The OTT connection 2050 may transfer both the request data and the user data. The client application 2032 may interact with the user to generate the user data that it provides.

It is noted that the host computer 2010, base station 2020 and UE 2030 illustrated in FIG. 20 may be identical to the host computer 1930, one of the base stations 1912a, 1912b, 1912c and one of the UEs 1991, 1992 of FIG. 19, respectively. This is to say, the inner workings of these entities may be as shown in FIG. 20, and, independently, the surrounding network topology may be that of FIG. 19.

In FIG. 20, the OTT connection 2050 has been drawn abstractly to illustrate the communication between the host computer 2010 and the UE 2030 via the base station 2020, without explicit reference to any intermediary devices and the precise routing of messages via these devices. Network infrastructure may determine the routing, which it may be configured to hide from the UE 2030 or from the service provider operating the host computer 2010, or both. While the OTT connection 2050 is active, the network infrastructure may further take decisions by which it dynamically changes the routing (e.g., on the basis of load balancing consideration or reconfiguration of the network).

The wireless connection 2070 between the UE 2030 and the base station 2020 is in accordance with the teachings of the embodiments described throughout this disclosure. One or more of the various embodiments improve the performance of OTT services provided to the UE 2030 using the OTT connection 2050, in which the wireless connection 2070 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 2050 between the host computer 2010 and UE 2030, in response to variations in the measurement results. The measurement procedure and/or the network functionality for reconfiguring the OTT connection 2050 may be implemented in the software 2011 of the host computer 2010 or in the software 2031 of the UE 2030, or both. In embodiments, sensors (not shown) may be deployed in or in association with communication devices through which the OTT connection 2050 passes; the sensors may participate in the measurement procedure by supplying values of the monitored quantities exemplified above, or supplying values of other physical quantities from which software 2011, 2031 may compute or estimate the monitored quantities. The reconfiguring of the OTT connection 2050 may include message format, retransmission settings, preferred routing etc.; the reconfiguring need not affect the base station 2020, and it may be unknown or imperceptible to the base station 2020. Such procedures and functionalities may be known and practiced in the art. In certain embodiments, measurements may involve proprietary UE signaling facilitating the host computer's 2010 measurements of throughput, propagation times, latency and the like. The measurements may be implemented in that the software 2011, 2031 causes messages to be transmitted, in particular empty or “dummy” messages, using the OTT connection 2050 while it monitors propagation times, errors etc.

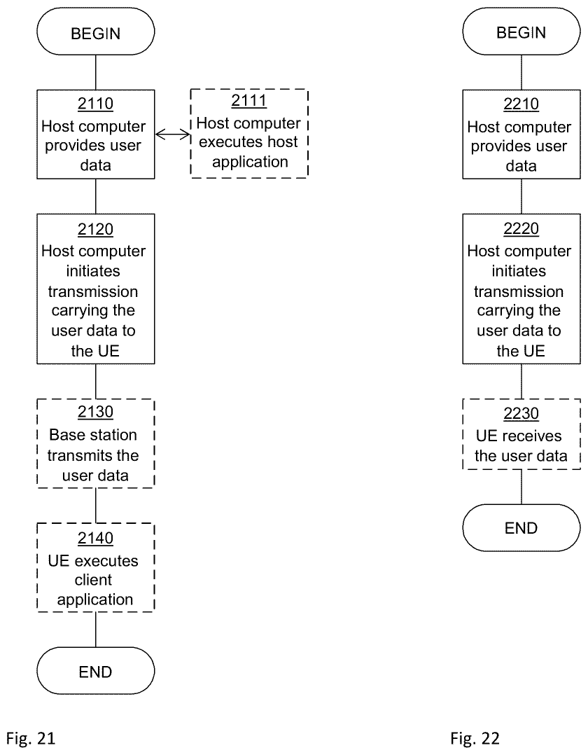

FIG. 21 is a flowchart illustrating a method implemented in a communication system, in accordance with one embodiment. The communication system includes a host computer, a base station and a UE which may be those described with reference to FIGS. 19 and 20. For simplicity of the present disclosure, only drawing references to FIG. 21 will be included in this paragraph. In a first step 2110 of the method, the host computer provides user data. In an optional substep 2111 of the first step 2110, the host computer provides the user data by executing a host application. In a second step 2120, the host computer initiates a transmission carrying the user data to the UE. In an optional third step 2130, the base station transmits to the UE the user data which was carried in the transmission that the host computer initiated, in accordance with the teachings of the embodiments described throughout this disclosure. In an optional fourth step 2140, the UE executes a client application associated with the host application executed by the host computer.

FIG. 22 is a flowchart illustrating a method implemented in a communication system, in accordance with one embodiment. The communication system includes a host computer, a base station and a UE which may be those described with reference to FIGS. 19 and 20. For simplicity of the present disclosure, only drawing references to FIG. 22 will be included in this paragraph. In a first step 2210 of the method, the host computer provides user data. In an optional substep (not shown) the host computer provides the user data by executing a host application. In a second step 2220, the host computer initiates a transmission carrying the user data to the UE. The transmission may pass via the base station, in accordance with the teachings of the embodiments described throughout this disclosure. In an optional third step 2230, the UE receives the user data carried in the transmission.

As has become apparent from above description, at least some embodiments of the technique ensure that paging messages will not be missed in a relay scenario due to PEI being sent or being not send in erroneous occasions.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following list of claims.

1. A method performed by a relay radio device for relaying a paging message from a network node to a remote radio device the method comprising or initiating the steps of:
receiving the paging message on a downlink, DL, from the network node at the relay radio device; and
relaying the received paging message on a sidelink, SL, from the relay radio device to the remote radio device,
wherein the paging message is selectively announced by a paging early indication, PEI, on the DL from the network node at the relay radio device depending on whether the relay radio device supports receiving of the PEI and/or independent of whether the remote radio device supports receiving of the PEI.

2. The method of claim 1, wherein the paging message is received in a paging occasion, PO, of the remote radio device.

3. The method of claim 1, wherein the paging message is received in a paging occasion, PO, of the relay radio device.

4. The method of claim 1, wherein the paging message is announced by receiving the PEI in the DL from the network node at the relay radio device.

5. The method of claim 1, wherein the paging message is announced by not receiving the PEI in the DL from the network node at the relay radio device.

6. The method of claim 1, wherein the paging message is selectively announced by the PEI from the network node at the relay radio device in accordance with whether a further paging message addressed to the relay radio device is announced by a or the PEI from the network node at the relay radio device.

7. The method of claim 1, wherein the paging message is addressed to the remote radio device, the method further comprising or initiating the step of:
receiving a or the further paging message in the DL from the network node at the relay radio device in a PO of the relay radio device, the further paging message being addressed to the relay radio device,
optionally wherein both the paging message addressed to the remote radio device and the further paging message addressed to the relay radio device are announced by the PEI from the network node at the relay radio device.

8. The method of claim 1, wherein the paging message is announced by the PEI in the DL from the network node at the relay radio device if the relay radio device supports the receiving of the PEI; and/or
wherein the paging message is not announced in the DL by a PEI from the network node if the relay radio device does not support the receiving of the PEI.

9. The method of claim 4, wherein the paging message is announced by transmitting a SL PEI in the SL from the relay radio device to the remote radio device if the remote radio device supports the receiving of the SL PEI; and/or
wherein the paging message is not announced in the SL by a SL PEI from the relay radio device if the remote radio device does not support the receiving of the SL PEI.

10. The method of claim 1, wherein one of the relay radio device and the remote radio device supports receiving the PEI, and
wherein the other one of the relay radio device and the remote radio device does not support receiving a PEI.

11. The method of claim 1, wherein the paging message is announced by the receiving of the PEI in the DL from the network node at the relay radio device if the relay radio device supports the receiving of the PEI; and
wherein the paging message is announced by forwarding the PEI in the SL from the relay radio device to the remote radio device if the remote radio device supports the receiving of the PEI.

12. The method of claim 1, wherein the relay radio device supports the receiving of the PEI based on at least one of the steps of:
receiving a configuration message in the DL from the network node at the relay radio device, wherein the configuration message configures the relay radio device to receive the PEI;
receiving a configuration message in the SL from the remote radio device at the relay radio device, wherein the configuration message configures the relay radio device to receive the PEI;
transmitting a capability message in an uplink, UL, from the relay radio device to the network node, the capability message being indicative of whether the relay radio device is capable of receiving the PEI; and
transmitting a or the capability message in the SL from the relay radio device to the remote radio device, the capability message being indicative of whether the relay radio device is capable of receiving the PEI.

13. The method of claim 1, wherein the remote radio device supports the receiving of the PEI based on at least one of the steps of:
transmitting a configuration message, or forwarding the configuration message, in the SL from the relay radio device to the remote radio device, wherein the configuration message configures the remote radio device to receive the PEI; and
receiving a capability message in the SL from the remote radio device at the relay radio device, the capability message being indicative of whether the remote radio device is capable of receiving the PEI.

14. The method of claim 1, wherein the PEI is a wake-up signal, WUS, or a go-to-sleep, GTS, signal.

15. The method of claim 1, wherein the PO is associated to the PEI by a predefined time offset relative to the PEI.

16. The method of claim 1, wherein the paging message comprises paging downlink control information, DCI, on a physical downlink control channel, PDCCH, of the network node and optionally at least one of:
a message on a physical downlink shared channel, PDSCH;
a message scheduled by the paging DCI;
a message indicative of radio resource control, RRC, signaling; and
a message indicative of system information, SI.

17. The method of claim 1, wherein the relay radio device monitors PEI occasions of the relay radio device for receiving the PEI in the DL, and wherein the PEI received in one of the monitored PEI occasions in the DL for announcing the paging message is indicative of a paging subgroup of at least one of the relay radio device and the remote radio device.

18. The method of claim 1, wherein the relay radio device monitors PEI occasions of the remote radio device for receiving the PEI in the DL, and wherein the PEI received in one of the monitored PEI occasions in the DL for announcing the paging message is indicative of a paging subgroup of at least one of the relay radio device and the remote radio device.

19. The method of claim 1, wherein the remote radio device is out of a radio coverage of the network node.

20. A method performed by a remote radio device for relaying a paging message from a network node to the remote radio device, the method comprising or initiating the steps of:
receiving the paging message on a sidelink, SL, from a relay radio device at the remote radio device in a SL paging occasion, PO, of the remote radio device; and
wherein the paging message is selectively announced by a SL paging early indication, PEI, on the SL from the relay radio device at the remote radio device depending on whether the remote radio device supports receiving of the SL PEI and/or independent of whether the relay radio device supports receiving of a PEI from the network node.

21. (canceled)

22. A method performed by a network node for relaying a paging message from the network node to a remote radio device, the method comprising or initiating the steps of:
transmitting the paging message on a downlink, DL, from the network node to a relay radio device for relaying the transmitted paging message on a sidelink, SL, from the relay radio device to the remote radio device,
wherein the paging message is selectively announced by a paging early indication, PEI, on the DL from the network node to the relay radio device depending on whether the relay radio device supports the receiving of the PEI and/or independent of whether the remote radio device supports the receiving of the PEI.

23. The method of claim 22, wherein the paging message is transmitted in a paging occasion, PO, of the remote radio device.

24. The method of claim 22, wherein the paging message is transmitted in a paging occasion, PO, of the relay radio device.

25. The method of claim 22, wherein the paging message is announced by transmitting the PEI in the DL from the network node to the relay radio device.

26. The method of claim 22, wherein the paging message is announced by not transmitting the PEI in the DL from the network node to the relay radio device.

27. (canceled)

28. (canceled)

29. A relay radio device for relaying a paging message from a network node to a remote radio device, the relay radio device comprising memory operable to store instructions and processing circuitry operable to execute the instructions, such that the relay radio device is operable to:
receive the paging message on a downlink, DL, from the network node at the relay radio device; and
relay the received paging message on a sidelink, SL, from the relay radio device to the remote radio device,
wherein the paging message is selectively announced by a paging early indication, PEI, on the DL from the network node at the relay radio device; depending on whether the relay radio device supports receiving of the PEI and/or independent of whether the remote radio device supports receiving of the PEI.

30.-48. (canceled)
